(19) United States
(12) Patent Application Publication
(10) Pub. No.: US 2026/0081694 A1
(43) Pub. Date: Mar. 19, 2026

(54) OPTICAL PHASED ARRAY WITH GRATING STRUCTURE

(71) Applicant: TAARA CONNECT, INC., SUNNYVALE, CA (US)

(72) Inventors: Paul Epp, Sunnyvale, CA (US); Devin Brinkley, Redwood City, CA (US)

(21) Appl. No.: 18/889,498

(22) Filed: Sep. 19, 2024

(51) Int. Cl. H04B 10/27; G02B 5/18; H04B 10/112; H04B 10/50

(52) U.S. Cl. CPC H04B 10/27; G02B 5/1814; G02B 5/1861; H04B 10/1123; H04B 10/506

(57) ABSTRACT

Aspects of the disclosure provide for a system including a first communications terminal. The first communications terminal may include a common aperture for transmitting signals and receiving signals and an optical phased array (OPA) architecture. The OPA architecture may include including a micro-lens array including a plurality of micro-lenses, each micro-lens of the plurality of micro-lenses having an additional grating structure on a surface of that micro-lens and being associated with a first pair of emitters, and each one of the pair of emitters being associated with a phase shifter. The OPA architecture may be configured for bidirectional communication with a second communications terminal.

### BACKGROUND

Wireless optical communication enables high-throughput and long-range communication, in part due to high gain offered by the narrow angular width of the transmitted beam. However, the narrow beam also requires that it must be accurately and actively pointed in order to remain aligned to an aperture of a communications terminal at the remote end. This pointing may be accomplished by small mirrors (e.g., MEMS or voice-coil based fast-steering mirror mechanisms) that are actuated to steer the beam. In other implementations, electro-optic steering of beams with no moving parts is used to steer the beam, which provides cost, lifetime and performance advantages. Optical Phased Arrays (OPAs) are a critical technology component, with added benefits of adaptive-optics, point-to-multipoint support, and mesh network topologies. Each active element in the OPA requires electro-optic phase shifting capability.

### BRIEF SUMMARY

Aspects of the disclosure provide a system. The system includes a first communications terminal. The first communications terminal includes a common aperture for transmitting signals and receiving signals and an optical phased array (OPA) architecture. The OPA architecture includes a micro-lens array including a plurality of micro-lenses, each micro-lens of the plurality of micro-lenses having an additional grating structure on a surface of that micro-lens and being associated with a pair of emitters, each one of the pair of emitters being associated with a phase shifter, and wherein the OPA architecture is configured for bidirectional communication with a second communications terminal.

In one example, the system also includes the second communications terminal. In this example, the second communications terminal transmits signals at a first wavelength and the second communications terminal transmits signals at a second wavelength different from the first wavelength. In addition, the first wavelength is within 2 nm or less of the second wavelength. In another example, the OPA architecture enables the transmitting and receiving signals to have wavelengths within 1 nm of one another. In another example, the additional grating structures are echelle grating structures. In another example, each of the surfaces is an outer surface of a respective micro-lens of the plurality of micro-lenses. In another example, each of the surfaces are an inner surface of a respective micro-lens of the plurality of micro-lenses. In another example, the pair of phase shifters includes a first phase shifters for transmitting signals and a second phase shifter for receiving signals. In another example, the pair of emitters includes a first emitter for transmitting signals and a second emitter for receiving signals. In another example, the transmitted signals have wavelengths within 2 nm or less of the received signals. In another example, the OPA architecture also includes a second pair of emitters for receiving first and second received signals and a second pair of phase shifters for receiving the first and second received signals. In this example, the pair of emitters are for transmitting first and second transmitted signals and the pair of phase shifters are for transmitting first and second transmitted signals. In addition, wherein the first and second receive signals have wavelengths within 2 nm or less of one another. In addition or alternatively, the first and second transmit signals have wavelengths within 2 nm or less of one another.

Another aspect of the disclosure provides a method of transmitting and receiving light in a communications terminal. The method includes receiving a receive signal through an aperture; passing the receive signal through an optical phased array (OPA) architecture including a micro-lens array including a plurality of micro-lenses, each micro-lens of the plurality of micro-lenses having an additional grating structure on a surface of that micro-lens and being associated with a pair of emitters, each one of the pair of emitters being associated with a phase shifter; passing a transmit signal through the OPA architecture including the additional grating structures; and sending the transmit signal through the aperture.

In one example, the additional grating structure is an echelle grating structure. In another example, a wavelength of the transmitted signal is within 2 nm or less of the received signal. In another example, each of the surfaces is an outer surface of a respective micro-lens of the plurality of micro-lenses. In another example, each of the surfaces is an outer surface of a respective micro-lens of the plurality of micro-lenses.

### BRIEF DESCRIPTION OF THE DRAWINGS

FIG. 1 is a block diagram of a system including a first communications terminal and a second communications terminal in accordance with aspects of the disclosure.

FIG. 2 is a pictorial diagram of an example system architecture for the first communication device of FIG. 1 in accordance with aspects of the disclosure.

FIGS. 3A and 3B represent features of an OPA architecture represented as an example OPA chip in accordance with aspects of the disclosure.

FIG. 4 is a pictorial diagram of a network in accordance with aspects of the disclosure.

FIG. 5 is a representation of the path of signals through a portion of an OPA chip in accordance with aspects of the disclosure.

FIG. 6 is a flow diagram in accordance with aspects of the disclosure.

### DETAILED DESCRIPTION

### Overview

The technology relates to an optical phased array (OPA) architecture for a communications terminal in a larger communications system. The OPA architecture may include a plurality of bidirectional features including a micro-lens array as well as a plurality of emitters, phase shifters, and waveguides that connect the components in the OPA. This architecture design for a single OPA architecture may enable simultaneous transmit and receive functions on a single chip, an OPA chip with an integrated circuit. Because the communications terminal may use a common aperture for transmit (Tx) and receive (Rx) signals for reasons of size, complexity, and inherent self-coalignment (e.g., bore sighting). However, this may result in the scattering of the strong Tx signals into the weaker Rx signal's channel, necessitating further separation components downstream. In other words, because the Tx and Rx signals (i.e., light) follow the same path in the OPA architecture and the back-scattered Tx signal may be relatively larger and stronger than the Rx signal which may impede the detection of the Rx signal. To address this, an additional grating structure may be utilized as discussed further below.

For example, an OPA architecture may include an OPA chip having a micro-lens array, a plurality of emitters, and a plurality of phase shifters. The micro-lens array may include a plurality of convex lenses that focus the Rx signals onto respective ones of the plurality emitters positioned at the focal points of the micro-lens array. Each micro-lens of the micro-lens array may be associated with a respective pair of emitters of the plurality of emitters. For example, each micro-lens may have a respective Tx emitter from which Tx signals are received and a respective Rx emitter to which the Rx signals are focused.

The plurality of emitters may be configured to generate a specific phase and intensity profile to increase the effective fill factor of the Rx signals and improve the wavefront of the Tx signals. Each emitter may be associated with a phase shifter. In this regard, each respective Tx emitter may be connected to a respective Tx phase shifter, and each Rx emitter may be connected to a respective Rx phase shifter.

The additional grating structure may be positioned such that the Tx signals pass through the additional grating structure immediately before or after the micro-lens array and the Rx signals pass through the additional grating structure immediately before or after the micro-lens array. The additional grating structure may be a diffraction grating structure such as an Echelle grating structure which disperses different wavelengths of light in the Tx and Rx signals. Echelle grating structures may have a configuration of grooves arranged in a ladder-like structure which may be optimized for use at high incidence angles and therefore in high diffraction orders, and may be particularly suited for use with OPAs as described here. Situating the additional grating structures on each of the micro-lenses, positions these grating structures right at the entrance aperture of the OPA chip and causes Tx and Rx to separate into neighboring focal spots. Without it, the micro-lenses in the micro-lens array would likely direct both Tx and Rx signals towards the same location (e.g., the same emitter). An Echelle grating structure may be particularly suited for this purpose because of its high angular dispersion which may allow for the use of Tx and Rx wavelengths that are closer together than a typical (conventional) diffraction gratings.

In addition, because the additional grating structures separate the Tx and Rx signals at each micro-lens of the micro-lens array, additional changes to the communications terminal may be made.

In operation, the Tx and Rx signals may pass through the additional grating structures of the micro-lens array in order to separate from one another. For example, a communications terminal may receive a signal through an aperture. The received signal may be passed through an optical phased array (OPA) including a micro-lens array including a plurality of micro-lenses. Each of the micro-lenses is associated with a pair of emitters, each one of the pair of emitters being associated with a phase shifter. A transmit signal may be sent through the optical phased array including the additional grating structures. This transmit signal may also be sent through the aperture.

The features described herein may provide an OPA architecture suitable for use in a communications terminal which utilizes Tx and Rx signals with very small differences in wavelengths. For instance, by imposing a separate wavelength for Tx and Rx signal and combining or adding an additional grating structure to the micro-lenses of the micro-lens array, the Tx and Rx signals outside the OPA architecture may share a common axis, and yet be physically separated in the area between the emitters and the micro-lenses of the micro-lens array. This may reduce the need for additional Tx or Rx separation components in the communications terminal as noted above. In addition, by separating the Tx and Rx signals and using distinct Tx and Rx emitters for each micro-lens in the micro-lens array, this may allow for bidirectional communication between two communications terminals which utilize different wavelengths in respective Tx signals. Moreover, while other similar approaches have been used in the past, such approaches were not used for free-space optical communications, with echelle gratings (which allow for closer wavelengths of Tx and Rx signals), or for the separation of both Tx and Rx signals as described herein.

### Example Systems

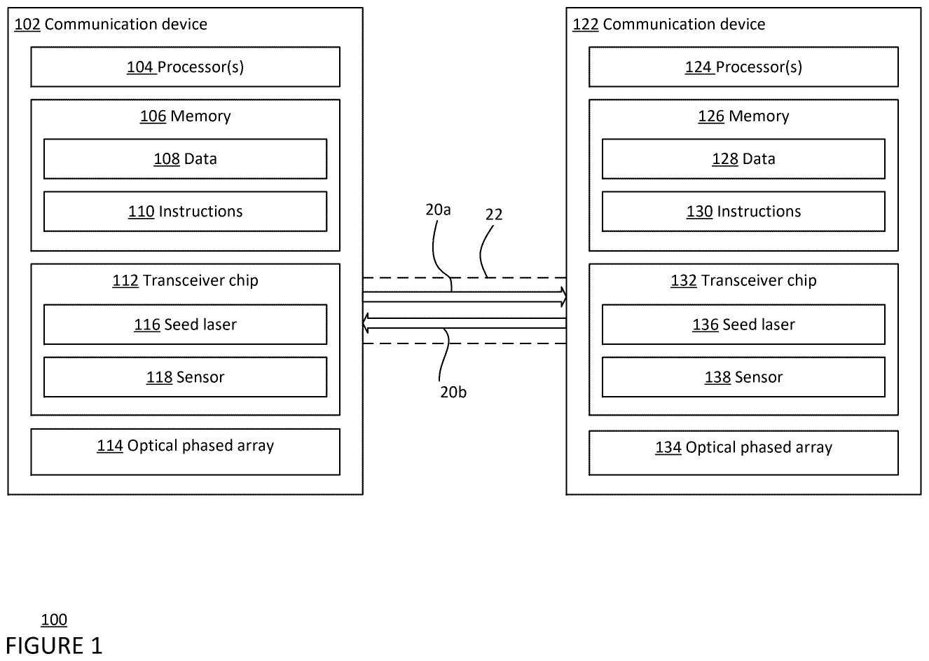

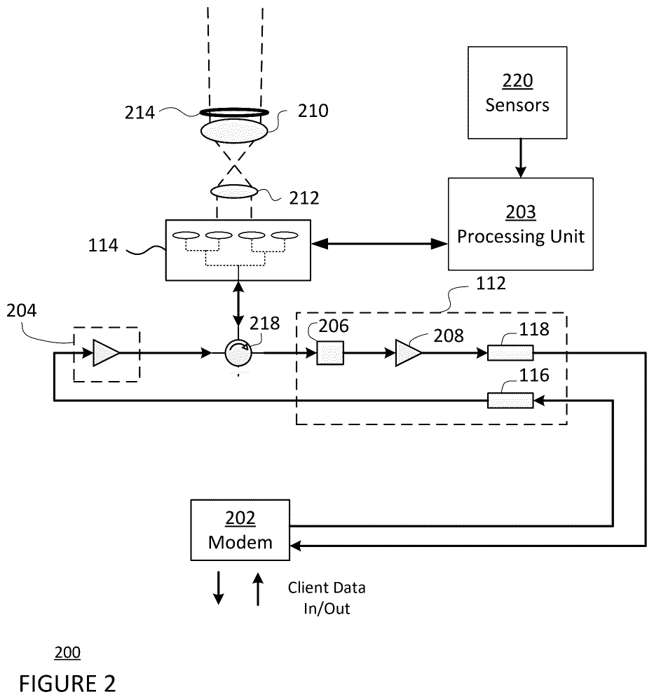

FIG. 1 is a block diagram of a system 100 including a first communications terminal configured to form one or more links with a second communications terminal, for instance as part of a system such as a free-space optical communication (FSOC) system. FIG. 2 is a pictorial diagram of an example communications terminal 200, such as the first communications terminal of FIG. 1. For example, a first communications terminal 102 includes one or more processors 104, a memory 106, a transceiver photonic integrated chip 112, and an optical phased array (OPA) architecture 114. In some implementations, the first communications terminal 102 may include more than one transceiver chip and/or more than one OPA architecture (e.g., more than one OPA chip).

The one or more processors 104 may be any conventional processors, such as commercially available CPUs. Alternatively, the one or more processors may be a dedicated device such as an application specific integrated circuit (ASIC) or another hardware-based processor, such as a field programmable gate array (FPGA). Although FIG. 1 functionally illustrates the one or more processors 104 and memory 106 as being within the same block, such as in a modem 202 for digital signal processing shown in FIG. 2, the one or more processors 104 and memory 106 may actually comprise multiple processors and memories that may or may not be stored within the same physical housing, such as in both the modem 202 and a separate processing unit 203. Accordingly, references to a processor or computer will be understood to include references to a collection of processors or computers or memories that may or may not operate in parallel.

Memory 106 may store information accessible by the one or more processors 104, including data 108, and instructions 110, that may be executed by the one or more processors 104. The memory may be of any type capable of storing information accessible by the processor, including a computer-readable medium such as a hard-drive, memory card, ROM, RAM, DVD or other optical disks, as well as other write-capable and read-only memories. The system and method may include different combinations of the foregoing, whereby different portions of the data 108 and instructions 110 are stored on different types of media. In the memory of each communications terminal, such as memory 106, calibration information, such as one or more offsets determined for tracking a signal, may be stored.

Data 108 may be retrieved, stored or modified by the one or more processors 104 in accordance with the instructions 110. For instance, although the system and method are not limited by any particular data structure, the data 108 may be stored in computer registers, in a relational database as a table having a plurality of different fields and records, XML documents or flat files. The data 108 may also be formatted in any computer-readable format such as, but not limited to, binary values or Unicode. By further way of example only, image data may be stored as bitmaps comprised of grids of pixels that are stored in accordance with formats that are compressed or uncompressed, lossless (e.g., BMP) or lossy (e.g., JPEG), and bitmap or vector-based (e.g., SVG), as well as computer instructions for drawing graphics. The data 108 may comprise any information sufficient to identify the relevant information, such as numbers, descriptive text, proprietary codes, references to data stored in other areas of the same memory or different memories (including other network locations) or information that is used by a function to calculate the relevant data.

The instructions 110 may be any set of instructions to be executed directly (such as machine code) or indirectly (such as scripts) by the one or more processors 104. For example, the instructions 110 may be stored as computer code on the computer-readable medium. In that regard, the terms “instructions” and “programs” may be used interchangeably herein. The instructions 110 may be stored in object code format for direct processing by the one or more processors 104, or in any other computer language including scripts or collections of independent source code modules that are interpreted on demand or compiled in advance. Functions, methods and routines of the instructions 110 are explained in more detail below.

The one or more processors 104 may be in communication with the transceiver chip 112. As shown in FIG. 2, the one or more processors in the modem 202 may be in communication with the transceiver chip 112, being configured to receive and process incoming optical signals and to transmit optical signals. The transceiver chip 112 may include one or more transmitter components and one or more receiver components. The one or more processors 104 may therefore be configured to transmit, via the transmitter components, data in a signal, and also may be configured to receive, via the receiver components, communications and data in a signal. The received signal may be processed by the one or more processors 104 to extract the communications and data.

The transmitter components may include at minimum a light source, such as seed laser 116. Other transmitter components may include an amplifier, such as a high-power semiconductor optical amplifier 204. In some implementations, the amplifier is on a separate photonics chip. The seed laser 116 may be a distributed feedback laser (DFB), light-emitting diode (LED), a laser diode, a fiber laser, or a solid-state laser. The light output of the seed laser 116, or optical signal, may be controlled by a current, or electrical signal, applied directly to the seed laser, such as from a modulator that modulates a received electrical signal. Light transmitted from the seed laser 116 is received by the OPA architecture 114.

The receiver components may include at minimum a sensor 118, such as a photodiode. The sensor may convert a received signal (e.g., light or optical communications beam), into an electrical signal that can be processed by the one or more processors. Other receiver components may include an attenuator, such as a variable optical attenuator 206, an amplifier, such as a semiconductor optical amplifier 208, or a filter.

The one or more processors 104 may be in communication with the OPA architecture 114. The OPA architecture may include a micro-lens array, an emitter associated with each micro-lens in the array, a plurality of phase shifters, and waveguides that connect the components in the OPA. The OPA architecture may be positioned on a single chip, an OPA chip. The waveguides progressively merge between a plurality of emitters and an edge coupler that connect to other transmitter and/or receiver components. In this regard, the waveguides may direct light between photodetectors or fiber outside of the OPA architecture, the phase shifters the waveguide combiners, the emitters and any additional component within the OPA. In particular, the waveguide configuration may combine two waveguides at each stage, which means the number of waveguides is reduced by a factor of two at every successive stage closer to the edge coupler. The point of combination may be a node, and a combiner may be at each node. The combiner may be a 2×2 multimode interference (MMI) or directional coupler.

The OPA architecture 114 may receive light from the transmitter components and outputs the light as a coherent communication beam to be received by a remote communications terminal, such as second communications terminal 122. The OPA architecture 114 may also receive light from free space, such as a communication beam from second communications terminal 122, and provides such received light to the receiver components. The OPA architecture may provide the necessary photonic processing to combine an incoming optical communications beam into a single-mode waveguide that directs the beam towards the transceiver chip 112. In some implementations, the OPA architecture may also generate and provide an angle of arrival estimate to the one or more processors 104, such as those in processing unit 203.

The first communications terminal 102 may include additional components to support functions of the communications terminal. For example, the first communications terminal may include one or more lenses and/or mirrors that form a telescope. The telescope may receive collimated light and output collimated light. The telescope may include an objective portion, an eyepiece portion, and a relay portion. As shown in FIG. 2, the first communications terminal may include a telescope including a first lens 210, a second lens 212, and an aperture 214 (or opening) through which light may enter and exit the communications terminal. For ease of representation and understanding, the aperture 214 is depicted as distinct from the first lens 210, though the first lens may be positioned within the aperture. The first communications terminal may include a circulator, such as a single mode circulator 218, that routes incoming light and outgoing light while keeping them on at least partially separate paths. The first communications terminal may include one or more sensors 220 for detecting measurements of environmental features and/or system components.

The first communications terminal 102 may include one or more steering mechanisms, such as one or more bias means for controlling one or more phase shifters, which may be part of the OPA architecture 114, and/or an actuated/steering mirror (not shown), such as a fast/fine pointing mirror. In some examples, the actuated mirror may be a MEMS 2-axis mirror, 2-axis voice coil mirror, or a piezoelectric 2-axis mirror. The one or more processors 104, such as those in the processing unit 203, may be configured to receive and process signals from the one or more sensors 220, the transceiver chip 112, and/or the OPA architecture 114 and to control the one or more steering mechanisms to adjust a pointing direction and/or wavefront shape. The first communications terminal also includes optical fibers, or waveguides, connecting optical components, creating a path between the seed laser 116 and OPA architecture 114 and a path between the OPA architecture 114 and the sensor 118.

The first communications terminal 102 may use a common aperture for transmit (Tx) and receive (Rx) signals for reasons of size, complexity, and inherent self-coalignment (e.g., bore sighting). However, this may result in the scattering of the strong Tx signal into the weak signal Rx channel, necessitating further Tx/Rx separation components downstream. In other words, because the Tx and Rx signals (i.e., light) follow the same path in the OPA architecture and the back-scattered Tx signal may be relatively larger and stronger than the Rx signal, which may impede the detection of the Rx signal. To address this, an additional grating structure may be utilized within the OPA architecture 114.

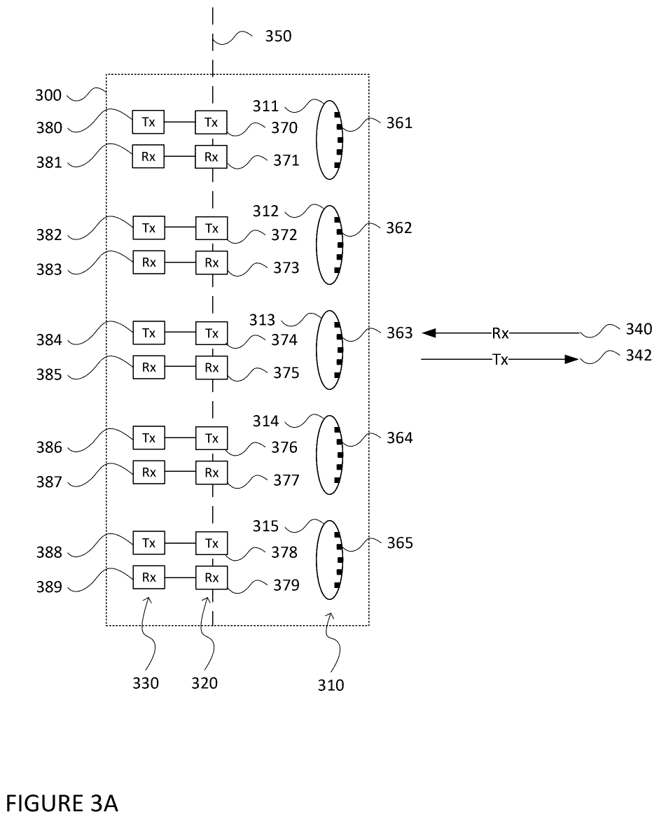

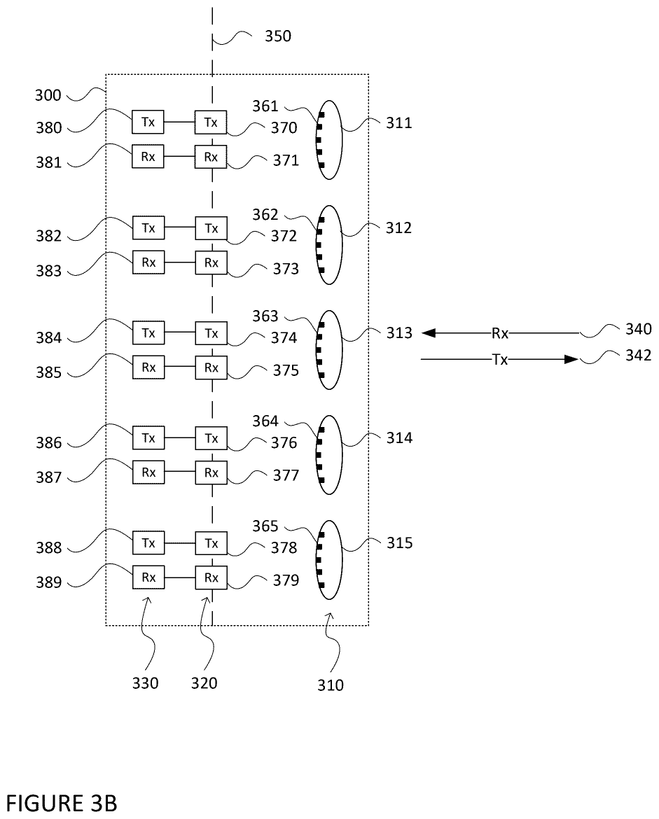

FIGS. 3A and 3B represent features of OPA architecture 114 represented as an example OPA chip 300 including representations of a micro-lens array 310, a plurality of emitters 320, and a plurality of phase shifters 330. For clarity and ease of understanding, additional waveguides and other features are not depicted. Arrows 340, 342 represent the general direction of Tx signals (transmitted optical communications beam) and Rx signals (received optical communications beam) as such signals pass or travel through the OPA chip 300.

The micro-lens array 310 may include a plurality of convex lenses 311-315 that focus the Rx signals onto respective ones of the plurality emitters positioned at the focal points of the micro-lens array. In this regard, the dashed-line 350 represents the focal plane of the micro-lenses 311-315 of the micro-lens array 310. The micro-lens array 310 may be arranged in a grid pattern with a consistent pitch, or distance, between adjacent lenses. In other examples, the micro-lens array 310 may be in different arrangements having different numbers of rows and columns, different shapes, and/or different pitch (consistent or inconsistent) for different lenses.

Each micro-lens of the micro-lens array may be 10's to 100's of micrometers in diameter and height. In addition, each micro-lens of the micro-lens array may be manufactured by molding, printing, or etching a lens directly into a wafer of the OPA chip 300. Alternatively, the micro-lens array 310 may be molded as a separately fabricated micro-lens array. In this example, the micro-lens array 310 may be a rectangular or square plate of glass or silica a few mm (e.g. 10 mm or more or less) in length and width and 0.2 mm or more or less thick. Integrating the micro-lens array within the OPA chip 300 may allow for the reduction of emitter size and an increase in the space between emitters. In this way, two-dimensional waveguide routing in the OPA architecture may better fit in a single layer optical phased array.

Each micro-lens of the micro-lens array may be associated with a respective pair of emitters of the plurality of emitters 320. For example, each micro-lens may have a respective Tx emitter from which Tx signals are received and a respective Rx emitter to which the Rx signals are focused. As an example, micro-lens 311 is associated with a Tx emitter 370 and an Rx emitter 371. Similarly, each of the micro-lenses 312-315 has respective Tx emitters 372, 374, 376, 378 and Rx emitters 373, 375, 377, 379. Each micro-lens in the micro-lens array may be shaped to remove the side lobes in a signal for the inverse transit beam as well as the receiver angular acceptance. This arrangement may thus increase the effective fill factor of the Rx signals at respective Rx emitters, while also expanding the Tx signals received at the micro-lenses from the respective Tx emitters before the Tx signals leave the OPA chip 300.

The plurality of emitters 320 may be configured to convert emissions from waveguides to free space and vice versa. The emitters may also generate a specific phase and intensity profile to further increase the effective fill factor of the Rx signals and improve the wavefront of the Tx signals. The phase and intensity profile may be determined using inverse design or other techniques in a manner that accounts for how transmitted signals will change as they propagate to and through the micro-lens array. The phase profile may be different from the flat profile of traditional grating emitters, and the intensity profile may be different from the Gaussian intensity profile of traditional grating emitters. However, in some implementations, the emitters may be Gaussian field profile grating emitters. The phase shifters 330 may allow for sensing and measuring Rx signals and the altering of Tx signals to improve signal strength optimally combining an input wavefront into a single waveguide or fiber. Each emitter may be associated with a phase shifter. As shown in FIGS. 3A and 3B, each respective Tx emitter may be connected to a respective Tx phase shifter, and each Rx emitter may be connected to a respective Rx phase shifter. As an example, the Tx emitter 370 is associated with a Tx phase shifter 380, and the Rx emitter 371 is associated with Rx phase shifter 381. The Rx signals received at the Rx phase shifters 381, 383, 385, 387, 389 may be provided to receiver components including the sensor 118, and the Tx signals from the Tx phase shifters 380, 382, 384, 386, 388 may be provided to the respective Tx emitters of the plurality of emitters 320. The architecture for the plurality of phase shifters 330 may include at least one layer of phase shifters having at least one phase shifter connected to a Tx emitter or an Rx emitter of the plurality of emitters 320. In some examples, the phase shifter architecture may include a plurality of layers of phase shifters, where phase shifters in a first layer may be connected in series with one or more phase shifters in a second layer.

The additional grating structure may be positioned such that the Tx signals pass through the additional grating structure immediately before or after the micro-lens array 310 and the Rx signals pass through the additional grating structure immediately before or after the micro-lens array. In this regard, an additional grating structure 361-365 (represented by the darkened grooves in the micro-lenses 311-315) may be incorporated into external surfaces (oriented towards from the plurality of emitters 320) of the micro-lenses of the micro-lens array 310 as depicted in FIG. 3A or onto internal surfaces (oriented towards from the plurality of emitters 320) of the micro-lenses of the micro-lens array 310 as depicted in FIG. 3B. For example, the additional grating structures 361-365 may be cut into or printed onto each micro-lens. Such a configuration may provide for an automatic alignment between the additional grating structures and the micro-lenses of the micro-lens array.

In instances where the micro-lens array 310 is a molded micro-lens array, the additional grating structure may be molded onto the side of the molded micro-lens array opposite of the micro-lens features (such as in the example configuration depicted in FIG. 3B). The micro-lens features may be molded onto one of the surfaces of the plate and the additional grating structure may be molded onto the opposite side of the plate. Such a configuration may provide for an automatic alignment between the additional grating structures and the micro-lens features of the molded micro-lens array. Also, the plate would save the losses associated with having more glass-air interfaces (though these may have anti-reflective coatings).

In other instances, rather than a physical micro-lens array, the function of the micro-lens array may be replicated using a diffractive optical element (DOE) array. In such instances, the additional grating and diffractive structure may be contained in one etched pattern.

The additional grating structure may be a diffraction grating structure such as an Echelle grating structure which disperses the different wavelengths of light in the Tx and Rx signals. Situating the additional grating structures on each of the micro-lenses, positions these grating structures right at the entrance aperture of the OPA chip and causes Tx and Rx to separate into neighboring focal spots. Without it, the micro-lenses in the micro-lens array would likely direct both Tx and Rx signals towards the same location (e.g., the same emitter). In this regard, to ensure that the wavelengths of the Tx and Rx signals are “different” enough, the specific wavelength of light used in the communications system may be assigned to each communications terminal. An Echelle grating structure may thus provide the high-angular dispersion necessary to have the Tx and Rx signals focus on separate emitters (e.g., the respective Tx and Rx emitters as described above) with relatively low or potentially no crosstalk. An Echelle grating structure may be particularly suited for this purpose because of its high angular dispersion which may allow for the use of Tx and Rx wavelengths that are closer together than a typical (conventional) diffraction gratings. For instance, an echelle grating structure may allow for the use of Tx and Rx wavelengths that differ by as little as 1 part in 1000 or less (e.g., in the 1500-1600 nm range, within 2 nm or less) which is not possible with conventional diffraction structures. For example, an echelle grating structure may facilitate the use of a wavelength of Tx signals of 1550 nm with a wavelength of Rx signals of 1552 nm. Of course, other combinations of wavelengths could be used.

In addition, because the additional grating structures separate the Tx and Rx signals at each micro-lens of the micro-lens array, additional changes to the communications terminal may be made. For example, the OPA architecture may include separate Tx and Rx emitters (as noted above) as well as independent sets of phase shifters, one for each of the Tx and Rx signals. In addition, in some examples, other features such as the circulator 218 or other filters may no longer be needed to separate the Tx and Rx signals.

While separate grating structures may be placed within or outside of the OPA architecture, doing so will require precision alignment between each micro-lens in the array which would likely be much more difficult and costly to achieve. In addition, there may be additional losses associated with having more glass-air interfaces (though these may have anti-reflective coatings).

Returning to FIG. 1, the second communications terminal 122 may output the Tx signals as an optical communications beam 20b (e.g., light) pointed towards the first communications terminal 102, which receives the optical communications beam 20b (e.g. light) as corresponding Rx signals. In this regard, the second communications terminal 122 includes one or more processors, 124, a memory 126, a transceiver chip 132, and an OPA architecture 134. The one or more processors 124 may be similar to the one or more processors 104 described above. Memory 126 may store information accessible by the one or more processors 124, including data 128 and instructions 130 that may be executed by processor 124. Memory 126, data 128, and instructions 130 may be configured similarly to memory 106, data 108, and instructions 110 described above. In addition, the transceiver chip 132 and the OPA architecture 134 of the second communications terminal 122 may be similar to the transceiver chip 112 and the OPA architecture 114. The transceiver chip 132 may include both transmitter components and receiver components. The transmitter components may include a light source, such as seed laser 136 configured similar to the seed laser 116. Other transmitter components may include an amplifier, such as a high-power semiconductor optical amplifier. The receiver components may include a sensor 138 configured similar to sensor 118. Other receiver components may include an attenuator, such as a variable optical attenuator, an amplifier, such as a semiconductor optical amplifier, or a filter. The OPA architecture 134 may include an OPA chip including a micro-lens array, a plurality of emitters, a plurality of phase shifters, which may be similar to OPA chip 300, micro-lens array 310, plurality of emitters 320, and plurality of phase shifters 330, respectively. Additional components for supporting functions of the communications terminal 122 may be included similar to the additional components described above. The communications terminal 122 may have a system architecture that is same or similar to the system architecture shown in FIG. 2.

A communication link 22 may be formed between the first communications terminal 102 and the second communications terminal 122 when the transceivers of the first and second communications terminals are aligned. The alignment can be determined using the optical communications beams 20a, 20b to determine when line-of-sight is established between the communications terminals 102, 122. Using the communication link 22, the one or more processors 104 can send communication signals using the optical communications beam 20a to the second communications terminal 122 through free space, and the one or more processors 124 can send communication signals using the optical communications beam 20b to the first communications terminal 102 through free space. The communication link 22 between the first and second communications terminals 102, 122 allows for the bi-directional transmission of data between the two devices. In particular, the communication link 22 in these examples may be free-space optical communications (FSOC) links. In other implementations, one or more of the communication links 22 may be radio-frequency communication links or other type of communication link capable of traveling through free space.

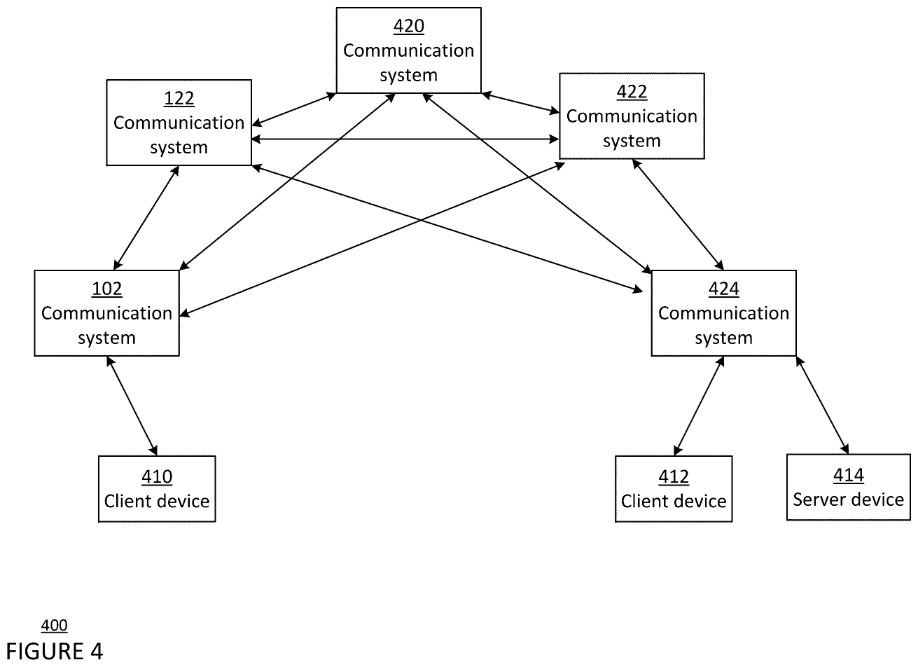

As shown in FIG. 4, a plurality of communications terminals, such as the first communications terminal 102 and the second communications terminal 122, may be configured to form a plurality of communication links (illustrated as arrows) between a plurality of communications terminals, thereby forming a network 400. The network 400 may include client devices 410 and 412, server device 414, and communications terminals 102, 122, 420, 422, and 424. Each of the client devices 410, 412, server device 414, and communications terminals 420, 422, and 424 may include one or more processors, a memory, a transceiver chip, an OPA architecture (e.g., OPA chip or chips) similar to those described above. Using the transmitter and the receiver, each communications terminal in network 400 may form at least one communication link with another communications terminal, as shown by the arrows. The communication links may be for optical frequencies, radio frequencies, other frequencies, or a combination of different frequency bands. In FIG. 4, the communications terminal 102 is shown having communication links with client device 410 and communications terminals 122, 420, and 422. The communications terminal 122 is shown having communication links with communications terminals 102, 420, 422, and 424.

The network 400 as shown in FIG. 4 is illustrative only, and in some implementations the network 400 may include additional or different communications terminals. The network 400 may be a terrestrial network where the plurality of communications terminals is on a plurality of ground communications terminals. In other implementations, the network 400 may include one or more high-altitude platforms (HAPs), which may be balloons, blimps or other dirigibles, airplanes, unmanned aerial vehicles (UAVs), satellites, or any other form of high-altitude platform, or other types of moveable or stationary communications terminals. In some implementations, the network 400 may serve as an access network for client devices such as cellular phones, laptop computers, desktop computers, wearable devices, or tablet computers. The network 400 also may be connected to a larger network, such as the Internet, and may be configured to provide a client device with access to resources stored on or provided through the larger computer network.

### EXAMPLE METHODS

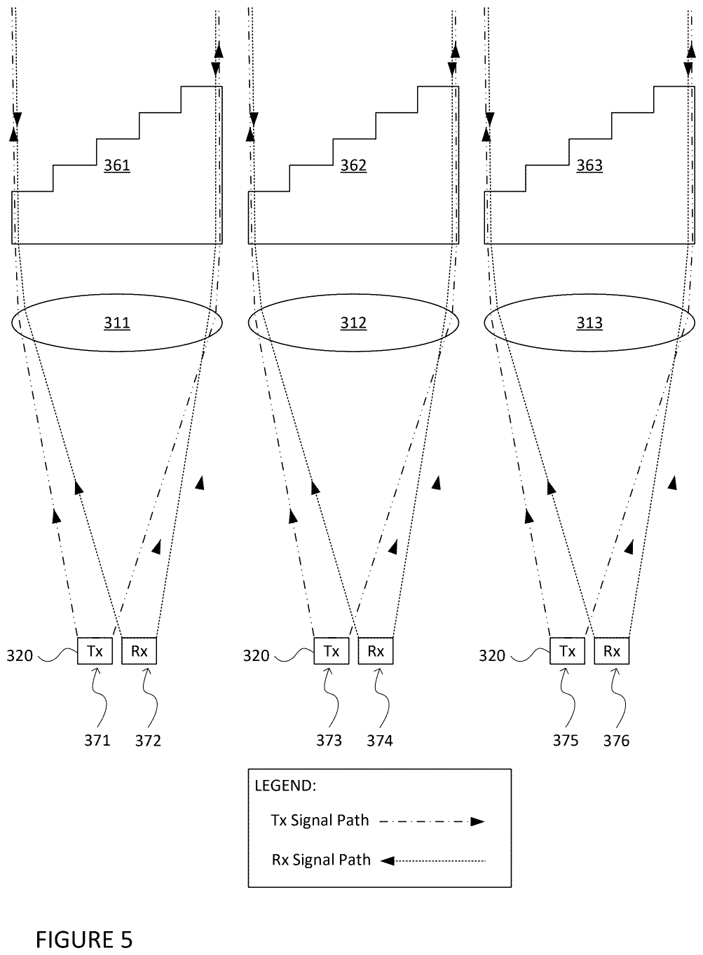

In operation, the Tx and Rx signals may pass through the additional grating structures of the micro-lens array in order to separate from one another. FIG. 5 is a representation of the path of Tx and Rx signals through a portion of the OPA chip 300 depicting lenses 311-313 of the micro-lens array 310, the additional grating structures 361-363, as well as the respective Tx and RX emitters 370-376 for the micro-lenses 311-313. In this example, the additional grating structures 361-363 are depicted as broken away from the micro-lens array 310 for ease of understanding, but are actually incorporated into external surfaces (oriented towards from the plurality of emitters 320) of the micro-lenses of the micro-lens array. In this regard, the example depicted in FIG. 5 corresponds to that depicted in FIG. 3A. The features depicted in FIG. 5 are not to scale and do not represent actual spacing/distances.

In this example, the Tx signals and Rx signals may represent two different wavelengths at least 1 nm apart from one another. For example, the wavelength of the Tx signals may be 1550 nm, and the wavelength of the Rx signals may be 1552 nm. Each of these signals may generally follow the same path in a different direction in free space between the two communications terminals 102 and 122.

Behind the additional grating structures 361-362 and toward the micro-lens, the two signals would propagate at different angles, due to the effect of the additional grating structures. The different angles would result in light falling at different spots behind the micro-lenses inside the OPA architecture 114. Each spot would have a respective Tx emitter or Rx emitter of the plurality of emitters 320 at its location, or rather, the locations of the Tx and Rx emitters 370-376. Finally, the light paths are reversible, so instead of two different colors coming into the OPA chip 300, the Rx signal comes into the OPA chip 300 and the Tx signal goes out of the OPA chip as shown in FIG. 5.

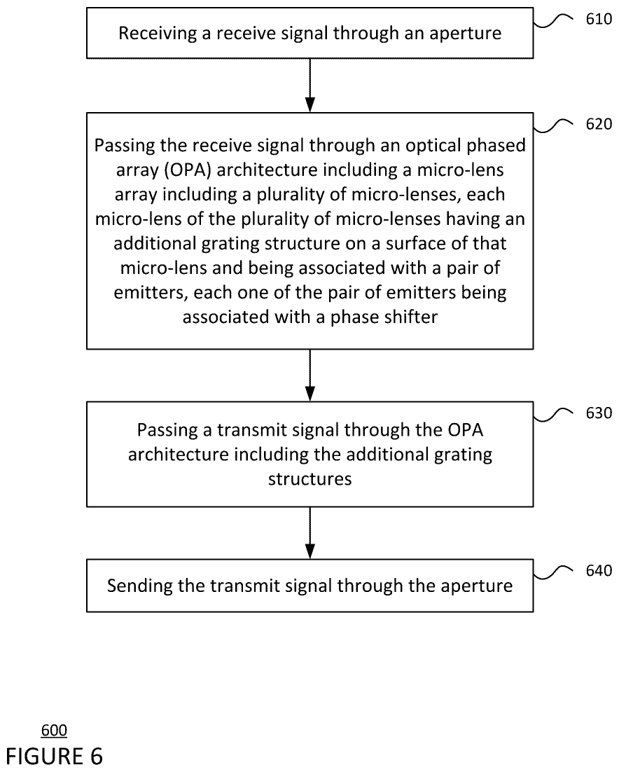

FIG. 6 is an example flow diagram 600 of transmitting and receiving signals in a communications terminal, such as the communications terminal 102 or 122, in accordance with some of the aspects described above. While FIG. 6 shows blocks in a particular order, the order may be varied and that multiple operations may be performed simultaneously. Also, operations may be added or omitted. In this example, the communications terminal 102 or 122 receives a signal through an aperture at block 610.

At block 620, the received signal is passed through an optical phased array (OPA) including a micro-lens array including a plurality of micro-lenses. Each micro-lens of the plurality of micro-lenses is associated with a pair of emitters, each one of the pair of emitters being associated with a phase shifter. For example, Rx signals may be passed through the communications terminal 102 to the OPA chip 300. As noted above, the OPA chip 300 may include a micro-lens array 310, a plurality of emitters 320 and phase shifters 330. Each of the micro-lenses 311-315 of the micro-lens array 310 is associated with a respective pair of the plurality of emitters 320, and each of the plurality of emitters is associated with a respective phase shifter. Each of the additional grating structures 361-365 may be an echelle grating structure arranged on or in an outer surface (represented in FIG. 3A) or an inner surface (represented in FIG. 3B) of a respective micro-lens of the plurality of micro-lenses.

At block 630 a transmit signal is sent through the optical phased array including the additional grating structures. The configuration of the micro-lens array 310 with the additional grating structures may allow for wavelengths of transmit signals that are within 2 nm or less of the received signal. At block 640, this transmit signal is also sent through the aperture.

The features described herein may be extended to the use of multiple Tx and Rx wavelengths. For instance, so long as the wavelengths are separated by at least 1-2 nm of light, an additional grating structure may be used to separate (or pull together) more than two wavelengths. For example, an Echelle grating structure may facilitate the use of wavelengths of Tx signals of 1550 nm and 1552 nm with wavelengths of Rx signals of 1554 nm and 1556 nm. Of course, other combinations of wavelengths could be used. Such a configuration would also require additional emitters for each wavelength for each micro-lens of the micro-lens array and additional phase shifters for each of the different wavelengths and corresponding emitters. Thus, in the example above with two Tx signal wavelengths and two Rx signal wavelengths, each micro-lens in the array would be associated with 4 emitters (one for each wavelength and Tx or Rx combination), and each of the 4 emitters would be associated with 4 phase shifters (one for each wavelength and Tx and Rx combination.

The features described herein may provide an OPA architecture suitable for use in a communications terminal which utilizes Tx and Rx signals with very small differences in wavelengths. For instance, by imposing a separate wavelength for Tx and Rx signal and combining or adding an additional grating structure to the micro-lenses of the micro-lens array, the Tx and Rx signals outside the OPA architecture may share a common axis, and yet be physically separated in the area between the emitters and the micro-lenses of the micro-lens array. This may reduce the need for additional Tx or Rx separation components in the communications terminal as noted above. In addition, by separating the Tx and Rx signals and using distinct Tx and Rx emitters for each micro-lens in the micro-lens array, this may allow for bidirectional communication between two communications terminals which utilize different wavelengths in respective Tx signals. Moreover, while other similar approaches have been used in the past, such approaches were not used for free-space optical communications, with echelle gratings (which allow for closer wavelengths of Tx and Rx signals), or for the separation of both Tx and Rx signals as described herein.

Unless otherwise stated, the foregoing alternative examples are not mutually exclusive, but may be implemented in various combinations to achieve unique advantages. As these and other variations and combinations of the features discussed above can be utilized without departing from the subject matter defined by the claims, the foregoing description of the embodiments should be taken by way of illustration rather than by way of limitation of the subject matter defined by the claims. In addition, the provision of the examples described herein, as well as clauses phrased as “such as,” “including” and the like, should not be interpreted as limiting the subject matter of the claims to the specific examples; rather, the examples are intended to illustrate only one of many possible embodiments. Further, the same reference numbers in different drawings can identify the same or similar elements.

1. A system comprising:
a first communications terminal comprising:
a common aperture for transmitting signals and receiving signals; and
an optical phased array (OPA) architecture including a micro-lens array including a plurality of micro-lenses, each micro-lens of the plurality of micro-lenses having an additional grating structure on a surface of that micro-lens and being associated with a pair of emitters, each one of the pair of emitters being associated with a phase shifter, and wherein the OPA architecture is configured for bidirectional communication with a second communications terminal.

2. The system of claim 1, further comprising the second communications terminal.

3. The system of claim 2, wherein the second communications terminal transmits signals at a first wavelength and the second communications terminal transmits signals at a second wavelength different from the first wavelength.

4. The system of claim 3, wherein the first wavelength is within 2 nm or less of the second wavelength.

5. The system of claim 1, wherein the OPA architecture enables the transmitting and receiving signals to have wavelengths within 1 nm of one another.

6. The system of claim 1, wherein the additional grating structures are echelle grating structures.

7. The system of claim 1, wherein each of the surfaces is an outer surface of a respective micro-lens of the plurality of micro-lenses.

8. The system of claim 1, wherein each of the surfaces are an inner surface of a respective micro-lens of the plurality of micro-lenses.

9. The system of claim 1, wherein the pair of phase shifters includes a first phase shifters for transmitting signals and a second phase shifter for receiving signals.

10. The system of claim 1, wherein the pair of emitters includes a first emitter for transmitting signals and a second emitter for receiving signals.

11. The system of claim 1, wherein the transmitted signals have wavelengths within 2 nm or less of the received signals.

12. The system of claim 1, wherein the OPA architecture further includes:
a second pair of emitters for receiving first and second received signals; and
a second pair of phase shifters for receiving the first and second received signals, wherein the pair of emitters are for transmitting first and second transmitted signals and the pair of phase shifters are for transmitting first and second transmitted signals.

13. The system of claim 12, wherein the first and second receive signals have wavelengths within 2 nm or less of one another.

14. The system of claim 12, wherein the first and second transmit signals have wavelengths within 2 nm or less of one another.

15. A method of transmitting and receiving light in a communications terminal, the method comprising:
receiving a receive signal through an aperture;
passing the receive signal through an optical phased array (OPA) architecture including a micro-lens array including a plurality of micro-lenses, each micro-lens of the plurality of micro-lenses having an additional grating structure on a surface of that micro-lens and being associated with a pair of emitters, each one of the pair of emitters being associated with a phase shifter;
passing a transmit signal through the OPA architecture including the additional grating structures; and
sending the transmit signal through the aperture.

16. The method of claim 15, wherein the additional grating structure is an echelle grating structure.

17. The method of claim 15, wherein a wavelength of the transmitted signal is within 2 nm or less of the received signal.

18. The method of claim 15, wherein each of the surfaces is an outer surface of a respective micro-lens of the plurality of micro-lenses.

19. The method of claim 15, wherein each of the surfaces are an inner surface of a respective micro-lens of the plurality of micro-lenses.
